(19) United States
(12) Patent Application Publication
(10) Pub. No.: US 2003/0214604 A1
(43) Pub. Date: Nov. 20, 2003

(54) Display system and method of controlling the same

(75) Inventor: Jae Kyung Lee, Buk-gu (KR)

Correspondence Address: FLESHNER & KIM, LLP, P.O. Box 221200, Chantilly, VA, 20153-1200, US

(73) Assignee: LG Electronics Inc.

(21) Appl. No.: 10/437,244

(22) Filed: May 14, 2003

(30) Foreign Application Priority Data
May 17, 2002 (KR) 2002-027424
May 21, 2002 (KR) 2002-028085

(51) Int. Cl. H04N 5/445; H04N 7/00; H04N 11/00

(52) U.S. Cl. 348/552; 348/564

(57) ABSTRACT

A display system includes a video input unit that receives video signals from one or more video sources, a control input unit, and a microprocessor. The microprocessor generates a switch signal according to a central control signal if a central control unit is determined to be operatively connected to the control input, where the central control signal is generated by the central control unit and is received through the control input unit. Then a switch included in the display system selects one of the received video signals according to and upon receiving the first switch signal. A display unit, which is further included in the display system, then displays the selected video signal according to the central control signal.

### CROSS-REFERENCE TO RELATED APPLICATIONS

This application claims the benefit of Korean Application No. P2002-27424 filed on May 17, 2002 and Korean Application No. P2002-28085 filed on May 21, 2002, which are hereby incorporated by reference as if fully set forth herein.

### BACKGROUND OF THE INVENTION

1. Field of the Invention

The present invention relates to a display system, and more particularly, to a display system and a method of controlling the display system using a central control unit.

2. Discussion of the Related Art

In general, the existing large-screen displays such as a plasma display panel (PDP) typically include a video input unit for receiving a video signal from a video source, a display unit for displaying the video signal, a local control unit (e.g., a remote control), a local control signal receiver for receiving a local control signal from the local control unit, and a microprocessor that generates control signals according to the received control signal.

For example, when a user presses a volume-up key provided on the local control unit (e.g., a remote control device or a control key panel provided on the display), then the control unit sends a corresponding local control signal, which includes one or more control codes corresponding to the pressed functional key, to the control signal receiver. Then the control signal receiver sends the received control signal to the microprocessor. The microprocessor decodes the control codes included in the control signal and generates control signals for performing an operational function corresponding to the decoded control codes.

However, when such large-screen displays are used in various public places such as airports, department stores, hotels, and train stations, it is extremely troublesome to walk to each of the multiple displays and individually control the display using a local control unit. Therefore, it would be highly preferable to be able to centrally control multiple displays in a public place using a central control unit such as a computer, so that a user in a display management office can individually control each display system operatively connected to the central control unit.

### SUMMARY OF THE INVENTION

Accordingly, the present invention is directed to a display system and a method of controlling the display system that substantially obviates one or more problems due to limitations and disadvantages of the related art.

An object of the present invention is to provide a display system that can be controlled by a central control unit, such as a computer, without adding any additional communication port to the display system.

A further object of the present invention is to provide a method of centrally controlling one or more display systems such that a user can control each display system by manipulating a central control unit, such as a computer, without adding any additional communication port to each display system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of controlling a display system comprises receiving video signals from one or more video sources though a video input unit of the display system, and controlling the display system according to a central control signal if a central control unit is operatively connected to a predetermined control input unit of the display system. The control input unit may be a communications port that would otherwise be connected to a set top box to receive both a video signal and control signals. In this method, the central control signal is generated by the central control unit. The controlling step may comprise receiving the central control signal through the control input unit, selecting a first video signal from the received video signals according to the received central control signal, and displaying the selected first video signal on a display screen.

In another aspect of the present invention, a display system comprises a video input unit for receiving video signals from one or more video sources, a control input unit, and a microprocessor that generates a first switch signal according to a central control signal if a central control unit is operatively connected to the control input unit. The central control signal is generated by the central control unit and is received through the control input unit. The display system further comprises a switch that selects a first video signal from the received video signals according to and upon receiving the first switch signal, and a display unit that displays the selected first video signal.

In another aspect of the present invention, a method of controlling a display system comprises receiving a video signal from a video source through a video input unit of the display system, and controlling the display system according to a central control signal if a central control unit is operatively connected to a predetermined control input unit of the display system. The central control signal is generated by the central control unit. The controlling step may comprise receiving the central control signal through the control input unit, selecting the received central control signal, and performing one or more operational functions indicated by the selected central control signal while displaying the received video signal on a display screen.

In other embodiments of the present invention, a display system comprises a video input source for receiving a video signal from a video source, a control input unit, and a microprocessor. The microprocessor generates a switch signal according to a central control signal if a central control unit is operatively connected to the control input unit. The central control signal is generated by the central control unit and is received through the control input unit. The display system further comprises a switch that selects the received central control signal according to and upon receiving the first switch signal, and a display unit that displays the received video signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a display system according to a first embodiment of the present invention;

FIG. 2 illustrates a method of controlling a display system according to the first embodiment of the present invention;

FIG. 3 illustrates a table that shows several examples of PC control data and corresponding control functions;

FIG. 4 illustrates a table summarizing control of a display system according to the first embodiment of the present invention;

FIG. 5 illustrates a display system according to a second embodiment of the present invention;

FIG. 6 illustrates a table that lists control codes and corresponding control functions; and

FIG. 7 illustrates a method of controlling a display system according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

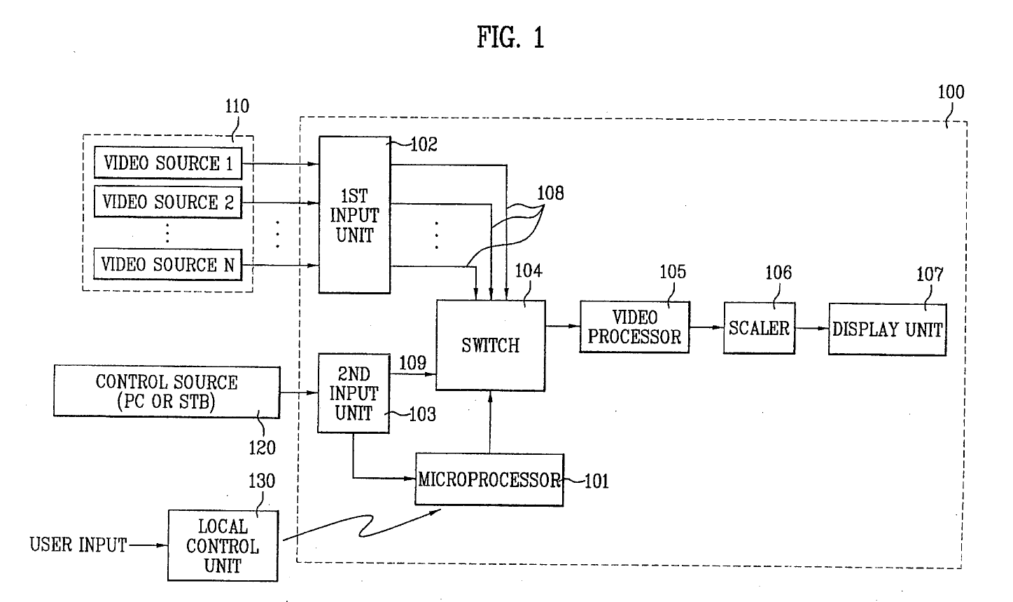

FIG. 1 illustrates a display system 100 according to a first embodiment of the present invention. According to FIG. 1, the display system 100 includes a first input unit 102 for receiving video signals from a plurality of video sources 110, a second input unit 103 connected to an external control source 120, which is either one of a central control unit (e.g., a computer) and a set-top box (STB). A microprocessor 101 is connected to the second input unit 103. The microprocessor 101 generates a switch signal based on whether a central control unit (e.g., a computer or a PC) or a set-top box is connected to the second input unit 103. The display system 100 shown in FIG. 1 further comprises a switch 104 connected to the first and second input units 102 and 103 through a plurality of input lines 108 and an input line 109, respectively. Upon receiving a switch signal from the microprocessor 101, the switch 104 selects one of the plurality of input lines 108 or the input line 109 according to the switch signal. The display system 100 further comprises a video processor 105 that processes the video signal received through the selected input line in order to generate displayable images, a scaler 106 that adjusts resolution of the processed video signal, and a display unit 107 that displays the resolution-adjusted signal.

The operation of the display system 100 shown in FIG. 1 will now be described in detail. The first input unit 102 included in the display system 100 is connected to the plurality of video sources 110 for receiving respective video signals from the video sources 110 and for transmitting the received video signals to the switch 104 through the respective video input lines 108. The plurality of video sources 110 may comprise a personal computer (PC), a digital video disk player (DVD), a digital television receiver (DTV), a video cassette recorder (VCR), and any other electronic device that is able to generate a video signal. The second input unit 103 is connected to the control source 120, which is either one of a central control unit (e.g., a computer or a PC) and a set-top box (STB), or some other type of control device. The second input unit 103 receives a control signal from the control source 120.

The second input unit 103, which is a communication port, could be connectable to a set-top box (STB) through a communication cable. Since the communication cable that connects the second input unit 103 of the display system 100 with the STB is identical to a parallel communication cable of a PC, a PC can also be easily connected to the second input unit 103 of the display system 100 without adding any additional communication port to the display system 100.

The microprocessor 101 controls the display system 100 based on whether the control source 120 is a PC or a STB. If the control source 120 connected to the second input unit 103 is determined to be a PC, then the microprocessor 101 initially receives a control signal from the PC and controls the display system 100 by selecting one of the plurality of video sources 110 and displaying a video signal received from the selected video source according to the received PC control signal. The microprocessor 101 could also generate control signals to various components of the display system 100 for performing one or more functions indicated by the PC control signal.

On the other hand, if the control source 120 is determined to be a STB, the microprocessor 101 receives a STB control signal and a video signal from the STB and controls the display system 100 according to the STB control signal. Similarly, it may further generate control signals to various components of the display system 100 for performing one or more functions indicated by the STB control signal.

However, if the microprocessor 101 determines that no control source is connected to the second input unit 103, it controls the display system 100 according to a local control signal that it receives from the local control unit 130, examples of which are a remote (local) control device or a control key panel provided on the display system 100. In this instance, the microprocessor 101 sends a switch control signal to the switch 104 to select one of the plurality of video sources 110 according to the local control signal. It may further generate control signals to various components of the display system 100 for performing one or more functions indicated by the local control signal.

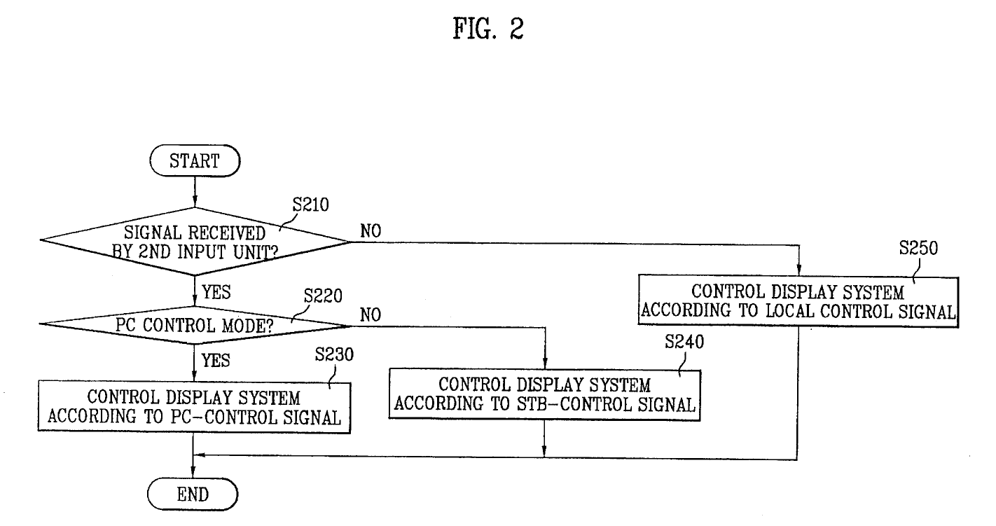

FIG. 2 illustrates a method of controlling a display system according to the first embodiment of the present invention. According to FIG. 2, the microprocessor 101 initially determines whether a control signal is inputted through the second input unit 103 (S210). If it is determined in step S210 that no control signal is received through the second input unit 103 (Local Control Mode), the microprocessor 101 controls the display system 100 according to a local control signal received from the local control unit 130 (S250). For example, the microprocessor 101 receives a local control signal from a remote (local) control unit or a control key panel provided on the display system. A user would make a video source selection by pressing one or more key buttons provided thereon. Thereafter, the microprocessor 101 further generates a switch control signal to the switch 104 for selecting one of the plurality of input lines 108 according to the user's selection, and the switch 104 outputs the video signal received through the selected input line.

On the other hand, if it is determined in step S210 that a control signal is received from a control source 120 through the second input unit 103, the microprocessor 101 further determines whether the connected control source 120 is a computer (PC) or a set-top box (STB) (S220). If the control source 120 is determined to be a PC, in step S220 (PC Control Mode), the microprocessor 101 controls the display system 100 according to a PC control signal received from the PC 120 through the second input unit 103 (S230). For example, the microprocessor 101 generates a switch control signal to the switch 104 for selecting one of the plurality of input lines 108 according to the PC control signal so that the switch 104 outputs a video signal received through the selected input line to the video processor 105. The microprocessor 101 may further generate control signals to various components of the display system 100 for performing other operation functions such as Power-Off, Power-On, Volume-Up, Volume Down, Channel-Up, Channel-Down, and Parallel-Disable according to the PC control signal.

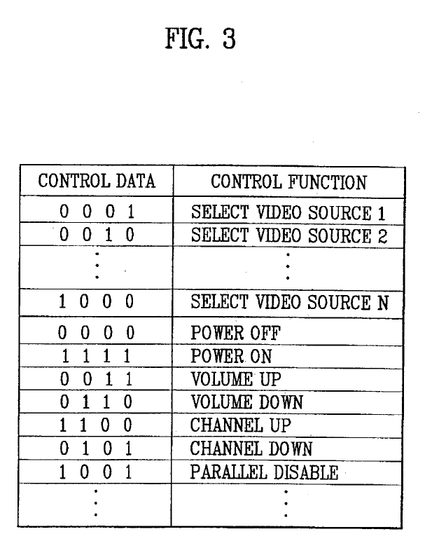

The PC-control signal may include one or more PC-control data sets and may be received from the PC 120 through a parallel or serial communication port. FIG. 3 illustrates a table that shows several examples of the PC control data sets (each having four binary bits) and their corresponding control functions. According to FIG. 3, the control data sets can be classified into two groups: a first group of data sets for selecting one of the plurality of video sources 110 and a second group of data sets for performing one or more operation functions (e.g., Power-Off, Power-On, Volume Up, Volume Down, Channel-Up, Channel-Down, and Parallel-Disable). For example, if the microprocessor 101 receives a PC control signal including control data sets of [0001 and 0110], the microprocessor 101 transmits a switch control signal to the switch 104 in order to select video source_1 and further generates control signals to perform Volume-Down function.

Referring back to FIG. 2, if the control source 120 is determined to be a set-top box (STB) in step S220 (STB Control Mode), the microprocessor 101 controls the display system 100 according to a STB control signal received from the STB 120 through the second input unit 103 (S240). In step S240, the microprocessor 101 generates a switch control signal to the switch 104 for switching to the input line corresponding to a desired video signal. In this instance, the video signal might be a video signal provided by the STB itself. The video signal from the STB might be input through the second input unit 103, rather that being input through the first input unit 102. Furthermore, the microprocessor 101 may generate control signals to various components of the display system 100 for performing one or more operations functions indicated in the STB control signal.

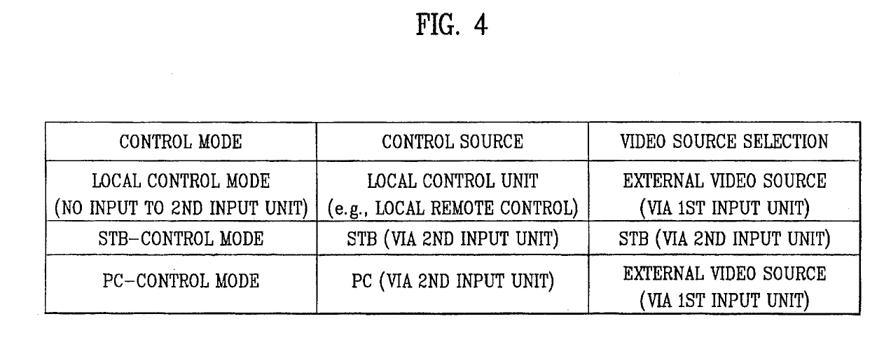

FIG. 4 illustrates a table summarizing video source selection in each control mode according to the first embodiment of the present invention. For example, in Local Control Mode, one of the external video sources 110 is selected according to a local control signal generated by the local control unit 130. In PC Control Mode, one of the external video sources 110 is selected according to a PC control signal generated by the PC 120. Lastly, in STB Control Mode, the switch 104 selects the input line 109 for receiving a video signal and a STB control signal from the STB 120.

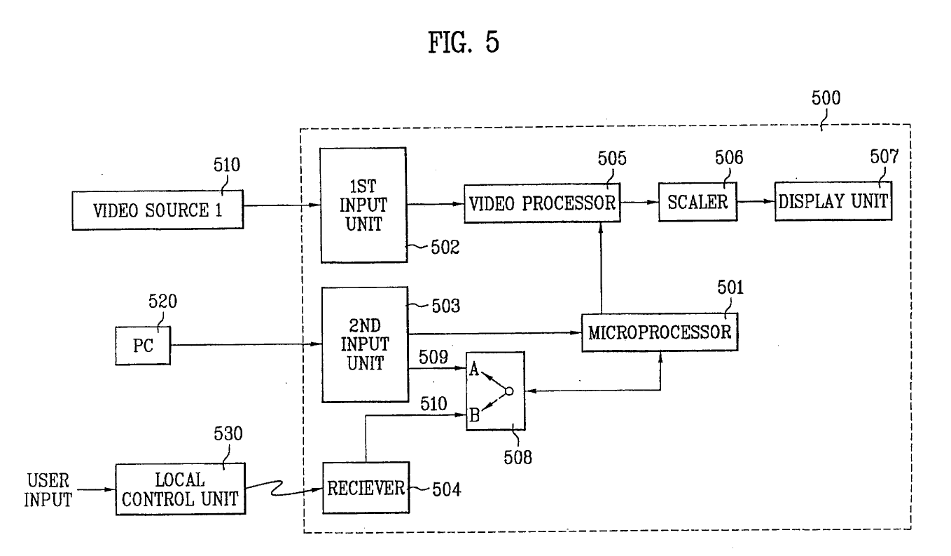

FIG. 5 illustrates a display system 500 according to a second embodiment of the present invention. According to FIG. 5, the display system 500 includes a first input unit 502 connected to an external video source 510 for receiving a video signal, a second input unit 503 connected to a central control unit (i.e., a computer or PC) 520 for receiving a PC control signal, a local control signal receiver 504 that receives a local control signal from a local control unit 530, a microprocessor 501 that generates a switch signal based on whether the computer 520 is connected to the second input unit 503, and a switch 508 selecting the PC control signal or the local control signal according to the switch control signal.

The display system 500 further includes a video processor 505, a scaler 506, and a display unit 507. The video processor 505 receives a video signal from the first input unit 502 and converts the received video signal into displayable images. Then the scaler 506 adjusts the resolution of the displayable images, and the display unit 507 displays the resolution-adjusted images.

The second input unit 503 is a communications port that connects the display system 500 to the PC 520. The second input unit 503 can be an RS-232C communication port, a parallel communication port, or any other type of typical communications port commonly found on a computer. In addition, the local control unit 520 can be any one of a remote (local) control device or a control key panel provided on the display system 500.

The microprocessor 501 controls the switch 504 based on whether the PC 520 is connected to the second input unit 503. If the PC 520 is connected, the microprocessor 501 generates a switch control signal to the switch 508 for selecting the control input line 509 connected to the second input line 503 in order to receive a PC control signal from the PC 520. Otherwise, the switch 508 selects the control input line 510 connected to the local control signal receiver 504 in order to receive a local control signal generated by the local control unit 530. Thereafter, the microprocessor 501 controls the display system 500 according to the received local control signal.

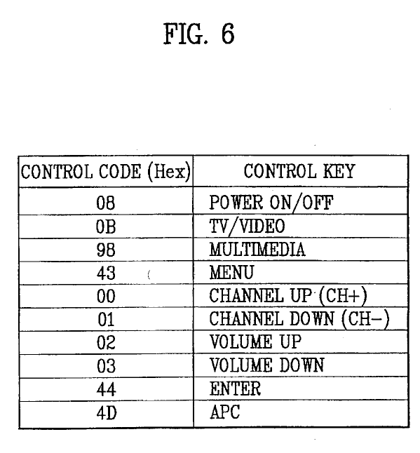

The control signal generated by the PC 520 or local control unit 530 includes one or more control codes, and FIG. 6 illustrates a table that shows various remote control codes and corresponding control functions. Upon receiving a control signal that includes one or more control key codes, the microprocessor 501 decodes the key codes and performs one or more corresponding function.

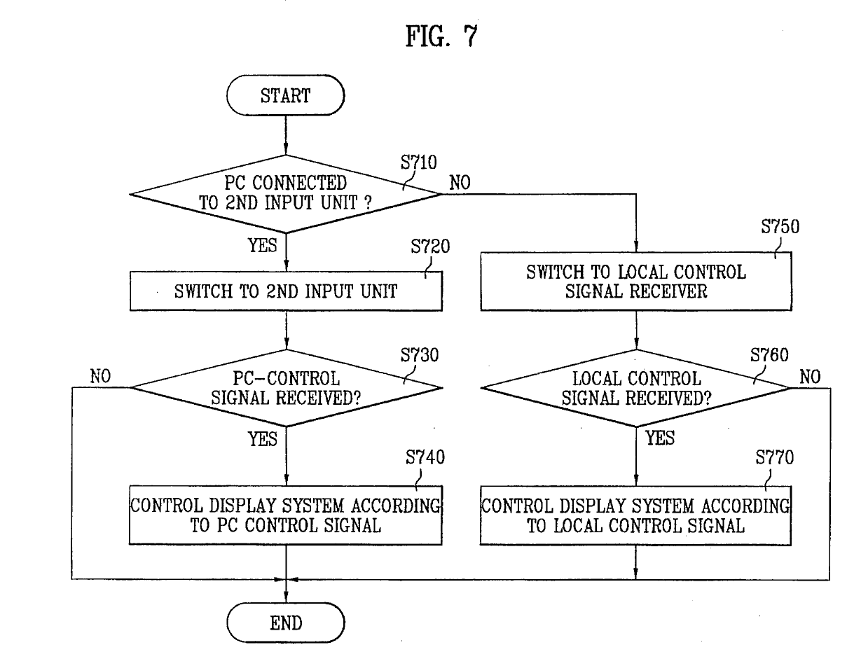

FIG. 7 illustrates a method of controlling the display system 500 according to the second embodiment of the present invention. Referring to FIG. 7, the microprocessor 501 initially determines whether the PC 520 is connected to the second input unit 503 (S710). If it is determined in step S710 that the PC 520 is connected, then the microprocessor 501 generates a switch control signal to the switch 508 to select the control input line 509 connected to the second input unit 503 (S720). Thereafter, the microprocessor 501 further determines whether a PC control signal generated by the PC 520 is received through the second input unit (S730). If it is determined in step S730 that the PC control signal is received, then the microprocessor 501 controls the display system 500 according to the received PC control signal (S740) by generating control signals to various components of the display system 500 for performing one or more operational functions, examples of which are shown in FIG. 6.

On the other hand, if it is determined in step S710 that the PC 520 is not connected to the second input unit 503, the microprocessor 501 generates a switch control signal to the switch 508 to select the control input line 510 connected to the remote control signal receiver 504 (750). Thereafter, it further determines whether a local control signal generated by the local remote control unit 530 is received (S760). If it is determined in step S760 that the local control signal is received, the microprocessor 501 generates control signals so that the display system 500 is controlled according to the received local remote control signal (S770). For example, the microprocessor 501 generates control signals to one or more components of the display system 500 for performing an operational function indicated in the local control signal.

As described above, the display system and method according to the present invention enable a remote user to control the display system through not only a local control unit, but also a central control unit such as a computer without adding any additional communication port into the display system. Therefore, efficiency of using the display system is greatly increased.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling a display system, the method comprising:
receiving video signals from a plurality of video sources through a video input unit of the display system; and
controlling the display system according to a central control signal when a central control unit is operatively connected to a central control input unit of the display system that is separate from a local control input unit, the central control signal being generated by the central control unit, wherein the controlling step comprises:
receiving the central control signal through the central control input unit;
selecting a video signal from one of the plurality of video sources based on the received central control signal.

2. The method of claim 1, wherein the controlling step further comprises performing one or more operational functions in response to the central control signal.

3. The method of claim 2, wherein the step of performing one or more operational functions comprises performing at least one of a turn-off function, a turn-on function, a volume-up function, a volume-down function, a channel-up function, a channel-down function and a parallel-disable function.

4. The method of claim 2, wherein the step of receiving the central control signal comprises receiving a central control signal that comprises first control data indicative of the video signal selection, and second control data indicative of the operational functions.

5. The method of claim 1, wherein the step of receiving the central control signal comprises receiving the central control signal through a parallel communication port of the display system.

6. The method of claim 1, wherein the step of receiving the central control signal comprises receiving the central control signal through an RS-232C communication port of the display system.

7. The method of claim 1, wherein the step of receiving the central control signal comprises receiving the central control signal through a central control input unit that is connectable to a set-top box.

8. The method of claim 1, wherein the central control signal is received from a computer.

9. The method of claim 1, further comprising controlling the display system according to a set-top box control signal when a set-top box is connected to the central control input unit, the set-top box control signal being generated by the set-top box, wherein the step of controlling the display system according to the set-top box control signal comprises:
receiving the set-top box control signal through the central control input unit; and
selecting a video signal received from the set-top box.

10. The method of claim 1, further comprising controlling the display system according to a local control signal when no control source is connected to the central control input unit, the local control signal being generated by a local control unit, wherein the step of controlling the display system according to the local control signal comprises:
receiving the local control signal from the local control unit; and
selecting a video signal from one of the plurality of video sources based on the received central control signal.

11. A display system, comprising:
a video input unit configured to receive video signals from a plurality of video sources;
a central control input unit that is separate from a local control input unit;
a microprocessor generating a first switch signal according to a central control signal when a central control unit is operatively connected to the central control input unit, the central control signal being generated by the central control unit and received through the central control input unit;
a switch configured to select one video signal from the received video signals according to the first switch signal; and
a display unit configured to display the selected video signal.

12. The display system of claim 11, wherein the microprocessor further generates control signals for performing one or more operational functions indicated by the central control signal.

13. The display system of claim 12, wherein the operational functions comprise turn-off, turn-on, volume-up, volume-down, channel-up, channel-down and parallel-disable functions.

14. The display system of claim 11, wherein the central control signal comprises first control data indicative of the video signal selection and second control data indicative of operational functions.

15. The display system of claim. 11, wherein the central control input unit is a parallel communication port.

16. The display system of claim 11, wherein the central control input unit is an RS-232C communication port.

17. The display system of claim 11, wherein the microprocessor further generates a second switch signal according to a set-top box control signal when a set-top box is connected to the central control input unit, the set-top box control signal being generated by the set-top box and received through the central control input unit, wherein the switch is also configured to select a video signal received from the set-top box according to the second switch signal.

18. The display system of claim 11, wherein the microprocessor generates a second switch signal according to a local control signal when no control source is connected to the central control input unit, the local control signal being generated by a local control unit, and wherein the switch is configured to select one video signal from the received video signals according to the second switch signal.

19. A method of controlling a display system, the method comprising:
receiving a video signal from a video source through a video input unit of the display system;
controlling the display system according to a central control signal when a central control unit is operatively connected to a central control input unit of the display system, the central control input unit being separate from a local control input unit, the central control signal being generated by the central control unit; and
controlling the display system according to a local control signal when no central control unit is operatively connected to the central control input unit of the display system, the local control signal being generated by the local control unit.

20. The method of claim 19, wherein the step of controlling the display system according to a central control signal comprises:
receiving the central control signal through the central control input unit;
performing one or more operational functions indicated by the central control signal while displaying the received video signal on a display screen.

21. The method of claim 20, wherein the step of performing one or more operational functions comprise performing at least one of a power-on, power-off, TV/Video selection, multimedia, menu, channel-up, channel-down, volume-up, volume-down and enter functions.

22. The method of claim 19, wherein the central control signal is received from a computer.

23. The method of claim 19, wherein the central control signal comprises one or more key codes indicating operational functions.

24. The method of claim 19, wherein the central control signal is received through a parallel communication port

25. The method of claim 19, wherein the central control signal is received through an RS-232 communication port.

26. The method of claim 19, wherein the step of controlling the display system according to the local control signal comprises:
receiving the local control signal through a local control input unit of the display system; and
performing one or more operational functions indicated by the local control signal while displaying the received video signal on the display screen.

27. A display system, comprising:
a video input unit receiving a video signal from a video source;
a central control input unit that is separate from a local control input unit;
a microprocessor generating a first switch signal according to a central control signal when a central control unit is operatively connected to the central control input unit, the central control signal being generated by the central control unit and received through the central control input unit;
a switch configured to select the received central control signal when the first switch signal is received from the microprocessor; and
a display unit configured to display the received video signal.

28. The display system of claim 27, wherein the microprocessor further generates control signals for performing one or more operational functions indicated by the central control signal.

29. The display system of claim 28, wherein the operational functions comprise power-on, power-off, TV/Video selection, multimedia, menu, channel-up, channel-down, volume-up, volume-down and enter functions.

30. The display system of claim 27, wherein the central control signal comprises one or more key codes indicative of the operational functions.

31. The display system of claim 27, wherein the central control input unit is a parallel communication port.

32. The display system of claim 27, wherein the central control input unit is an RS-232C communication port.

33. The display system of claim 27, wherein the microprocessor generates a second switch signal when no central control unit is connected to the central control input unit, and wherein the switch selects a local control signal from a local control unit when the second switch signal is received from the microprocessor.
